(19) United States
(12) Patent Application Publication
(10) Pub. No.: US 2026/0203440 A1
(43) Pub. Date: Jul. 16, 2026

(54) AUTOMATED DATA PROTECTION

(71) Applicant: Wells Fargo Bank, N.A., San Francisco, CA (US)

(72) Inventors: Brijesh Rai Chawla, Eden Prairie, MN (US); Scott D. Hutula, Concord, NC (US); Steven A. Jolley, Chester, SC (US); Richard Kenneth Kier, Eagan, MN (US); Alina Dragoslava Rodean, Hilliard, OH (US); Ravi Kumar Sarvepalli, Matthews, NC (US)

(21) Appl. No.: 19/025,147

(22) Filed: Jan. 16, 2025

(51) Int. Cl. G06F 21/62; G06F 21/60

(52) U.S. Cl. CPC G06F 21/6245; G06F 21/602

(57) ABSTRACT

A method involves receiving a data item request API call for personally identifiable information (PII) associated with a user identifier, retrieving prior requests for PII, accessing a data protection policy structure, and executing a data protection policy model. If combining the data item with previously requested items violates a rule stored in the data protection policy structure, the data item request is denied. Additionally, a data loss prevention rule for PII associated with the user identifier is executed.

### BACKGROUND

In the field of data security and compliance, organizations face numerous challenges in managing and protecting sensitive information. Additionally, regulatory requirements impose stringent guidelines on how data should be handled, stored, and disposed of, adding layers of complexity to data management practices.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Like numerals having different letter suffixes may represent different instances of similar components. Some embodiments are illustrated by way of example, and not limitation, in the figures of the accompanying drawing.

FIG. 1 is an illustration of components of a client device and an application server, according to various examples.

FIG. 2 is a block diagram illustrating the processing of a series of data item requests according to various examples.

FIG. 3 illustrates actions taken in response to a data loss prevention rule, according to various examples.

FIG. 4 is a diagram illustrating pipelines for training and using a machine learning model, according to various examples

FIG. 5 is a flowchart illustrating a method to execute a data mitigation rule, according to various examples.

FIG. 6 is a block diagram illustrating a machine in the example form of computer system, within which a set or sequence of instructions may be executed to cause the machine to perform any one of the methodologies discussed herein, according to various examples.

### DETAILED DESCRIPTION

Ensuring personally identifiable information (PII) is available to internal verification processes while securing it against unauthorized access presents a complex technical challenge. On the one hand, internal processes need to be able to verify PII to function correctly, such as for authentication or authorization purposes. On the other hand, securing PII against unauthorized access is crucial to prevent data breaches and compliance risks. This creates a tension between making PII available internally while maintaining security controls to prevent unauthorized access. As a result, organizations have security controls, such as encryption, access control lists (ACLs), and data masking, to protect PII while still allowing internal processes to verify it as needed.

A nefarious actor may request PII using valid credentials by exploiting trusted relationships and access controls. For instance, a compromised employee may use their legitimate login credentials to request additional PII than necessary for their official tasks, thereby gaining unauthorized access to sensitive data. This may occur when an employee's credentials are compromised due to phishing, password cracking, or other unauthorized access.

Additionally, a nefarious actor may utilize legitimate processes and APIs to scrape databases or request PII above what is necessary for the intended purpose. For example, a legitimate API key may be used to access a database and retrieve sensitive information. Still, the actor may modify the code or parameters to request more data than required. This may lead to a significant breach of PII, as the actor is able to exploit the trust and access granted by legitimate credentials.

Manually checking each request for PII is not a practical solution for several reasons. For example, manual checks are time-consuming and cannot keep pace with the volume of requests that internal processes generate. As the number of requests increases, manual checks become impractical and may lead to delays or missed requests. Furthermore, manual checks are inherently slow and cannot keep pace when real-time access to PII is often required for internal processes to function efficiently. Additionally, manual checks may not be sufficient to evaluate the nuances of access controls and regulatory requirements, leading to potential compliance risks or security vulnerabilities.

Given the above problems, automated systems and methods are described herein to check whether or not the request for PII is legitimate at the time it is requested. For example, PII requests are evaluated in real-time. The system may use machine learning algorithms and real-time data analytics to rapidly assess the legitimacy and authorization of each PII request, ensuring that sensitive data is accessible to authorized internal processes.

By automating the evaluation process, this system eliminates the need for manual checks and reduces the risk of human error. It also ensures consistent and accurate decision-making, even in complex scenarios, by leveraging the nuances of machine learning to identify patterns and anomalies indicative of valid or invalid requests.

Moreover, the described systems and method provide a tiered escalation approach to PII management with increasing levels of PII protection. For example, if a request is determined to be nefarious, a first mitigation step may be to distribute PII data to multiple servers and delete it from the original server. A second mitigation step may be to break up individual data items into subcomponents.

The following description outlines specific examples to provide a thorough understanding of various inventive aspects. It will be evident, however, to one skilled in the art that the present invention may be practiced without these specific details. References in the specification to “one example,” “an example,” “an illustrative example,” etc., indicate that the example described may include a particular feature, structure, etc. Still, every example may not necessarily include that particular feature. Additionally, such phrases do not imply a single example, and the features may be incorporated into other examples described. It may be appreciated that lists in the form of “at least one A, B, and C” may mean (A); (B); (C): (A and B); (B and C); or (A, B, and C). Similarly, items listed in the form of “at least one of A, B, or C” can mean (A); (B); (C): (A and B); (B and C); or (A, B, and C). Furthermore, using such phrases does not negate the possibility of other options (e.g., (D)).

Throughout this disclosure, components may perform electronic actions in response to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. End-users or administrators may use user interfaces to edit the variable values.

In various examples described herein, user interfaces are described as being presented to a computing device. The presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples, these portions may be displayed on a screen simultaneously, in others, the portions/elements may be displayed on separate screens such that not all portions/elements are displayed simultaneously. Unless explicitly indicated as such, the use of “presenting a user interface” does not infer either one of these options.

Additionally, the elements and portions are sometimes described as being configured for a particular purpose. For example, an input element may be configured to receive an input string, a selection from a menu, a checkbox, etc. In this context, “configured to” may mean presenting a user interface element capable of receiving user input. “Configured to” may additionally mean computer executable code processes interactions with the element/portion based on an event handler. Thus, a “search” button element may be configured to pass text received in the input element to a search routine that formats and executes a structured query language (SQL) query to a database.

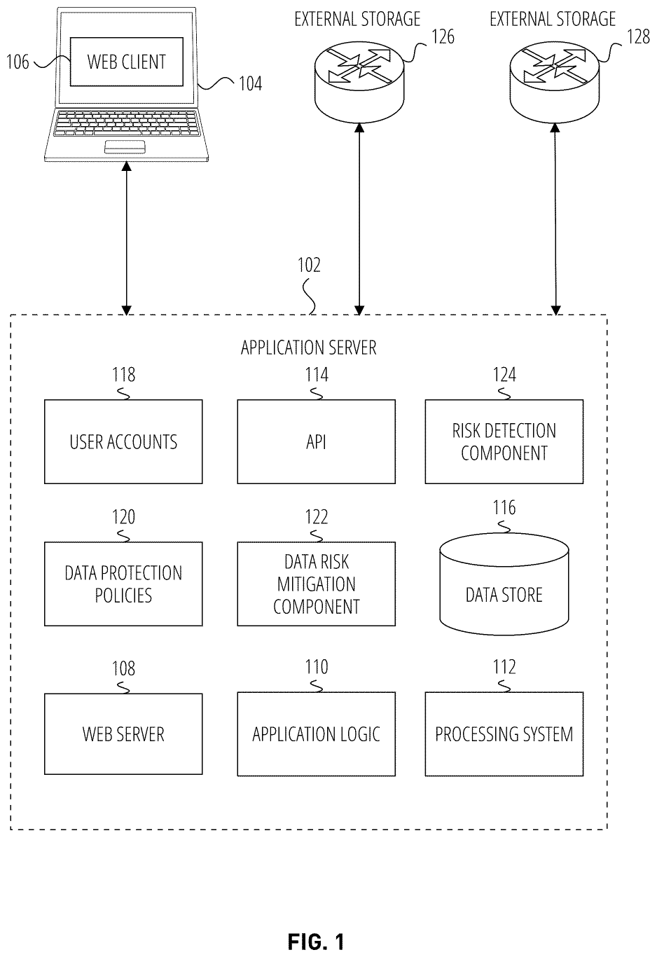

FIG. 1 illustrates the components of a client device and an application server according to various examples. Client device 104 may be a computing device which may be, but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., specially configured user interfaces). In some embodiments, computing devices may comprise one or more of a touch screen, camera, keyboard, microphone, or Global Positioning System (GPS) device. In various examples, client device 104 may issue data item requests to application server 102.

Client device 104 and application server 102 may communicate via a network (not shown). The network may include local-area networks (LAN), secure wide-area networks (WAN), wireless networks (e.g., 802.11 or cellular network), Public Switched Telephone Network (PSTN), ad hoc networks, cellular, personal area networks or peer-to-peer (e.g., Bluetooth®, Wi-Fi Direct), or other combinations or permutations of network protocols and network types. The network may include a single Local Area Network (LAN), Wide-Area Network (WAN), or combinations of LANs or WANs, such as the Internet.

User accounts 118 may store data items related to a user. The data items may be stored in a single location (e.g., data store 116). These items can be categorized into direct information, such as the user's name, address, and credentials, and indirect information, such as behavioral data. Behavioral data may be accumulated over time and may include patterns of login access, login locations, and behavioral biometrics, among other metrics. Both direct and indirect categories of data items may be considered personally identifiable information (PII), alone or in combination with other data items. For example, an access pattern alone may not be PII, but if combined with other indirect data items may be considered PII if a user may be identified with reasonable certainty based on the combined data set.

Each user account may have a stored associated risk level used in conjunction with the data risk mitigation component 122 to determine how data items for the user should be stored. For instance, when a user account attains a certain risk level, a data loss prevention rule from a data protection policy may be activated. The risk level may be determined by the risk detection component 124. The risk level can trigger a “frozen” state for the user account that may require additional authorization for any actions associated with the account. Risk levels may escalate incrementally or jump multiple levels, depending on the specific data protection policy rule being violated.

User accounts 118 may include user profiles on users of application server 102. A user profile may include credential information such as a username and hash of a password. A user may enter their username and plaintext password on a login page of application server 102 to view their user profile information or interfaces presented by application server 102 in various examples. Over time, data items (e.g., behavioral metrics, interests, etc.) may be stored as associated with a user account.

The risk detection component 124 may assess and manage potential threats to data security related to PII. The risk detection component 124 evaluates the risk level associated with individual data requests, user accounts, processes, and systems. When a request for a data item is received, the risk detection component 124 may process the request by applying one or more policies from the data protection policies 120. The outcome of the policy evaluation may include an output from a machine learning model or a determination that a threshold risk level has been exceeded. For example, the risk detection component 124 may use a scoring system ranging from 0 to 1, where values between 0 and 1 correspond to different outputs of the policies. This scoring system quantifies the risk associated with each request.

The risk detection component 124 may also evaluate the risk for a given process or server. For instance, if repeated requests from a particular server are deemed high risk by a policy evaluation, the risk detection component 124 may indicate that the entire server has been compromised.

The risk detection component 124 may analyze access patterns and behaviors to detect anomalies that may indicate malicious intent or misuse by insiders. For example, the risk detection component 124 may monitor for unusual access times, high data download volumes, or access from unauthorized locations. By establishing baseline activities through behavioral analytics, the risk detection component 124 may detect deviations (e.g., exceeding a threshold change in value) from these baselines that may signify a security threat.

The risk detection component 124 may also be configured to detect if a user is combining data across multiple sources without a legitimate need. For example, if a customer service representative is collecting data even after having enough to satisfy “Know Your Customer” rules, the risk detection component 124, via data risk mitigation component 122, may trigger an automatic deletion of the data.

“Associated” in the context of linking an account to a user profile (or other data linkages described herein) may be implemented differently depending on the underlying database system. For example, in a relational database management system (RDBMS), “associated” may refer to the relationship between tables. The relationship could be one-to-one, one-to-many, or many-to-many, established through foreign key constraints. For example, in a one-to-many relationship, a record in Table A (e.g., the user profile table) may be associated with multiple records in Table B (e.g., a data item table), using a foreign key in Table B that references the primary key in Table A.

In various examples, the data protection policies 120 provide a structured framework for managing and enforcing data security measures. The data protection policies 120 may be stored as Boolean logic rules, which operate on an “if this, then that” basis or other algorithmic formats. The rules may vary in complexity depending on the specific requirements of the data protection strategy. For instance, a Boolean logic rule might specify that if a data retention period has expired, the data that the data protection policy is for be deleted.

In addition to Boolean logic rules, the data protection policies 120 may include algorithmic rules (e.g., a weighted sum, regression analysis) that take input parameters such as metadata. Metadata may include the location of a request, the time of a request, and the entity identifier making the request. These algorithmic rules can evaluate the context of a data request and determine whether the data request complies with the established data protection policies. For example, an algorithmic rule might deny a data request if the data request originates from an unauthorized location or at an unusual time compared to prior requests.

The data protection policies 120 may also be task-based. For example, a data item request may include a reason for the request. For example, a request for a data item may include a parameter in an API call specifying the task that needs the data item (e.g., as encoded in a numerical format or using a standardized vocabulary) for the request. If the task does not require the data item, the policy may be breached, and the request may be denied. The application server 102 may store task data structures (e.g., extensible markup language) that identify the type of data items used to complete the task.

Pattern-based rules within the data protection policies 120 may utilize machine learning models trained on labeled past access patterns. These models, such as Long Short-Term Memory (LSTM) neural networks, may detect deviations from prior access patterns for the requesting entity identifier. The entity identifier may be a process identifier or an employee identifier. For example, if a user requests more than a specified number of data items on a user, the policy may be breached, indicating potential misuse or a security threat.

Explicit rules within the data protection policies 120 may be event-driven. For instance, if a user account is closed, personally identifiable information (PII) data may be deleted even before the retention policy period for the PII has expired. This proactive approach ensures that sensitive data is not retained longer than necessary, minimizing the risk of data breaches.

The data protection policies 120 may interact with other components of the system, such as the risk detection component 124 and the data risk mitigation component 122. When a data item request is received, the risk detection component 124 evaluates the request against the data protection policies 120. The data risk mitigation component 122 implements the appropriate mitigation response if a policy is breached.

The data risk mitigation component 122 interacts with the user account user accounts 118 and the risk detection component 124 to manage and mitigate risks associated with data security. The data risk mitigation component 122 implements various data loss prevention rules based on the risk level of a user account or server. These responses may include distributing user data items, segmenting individual data items, deleting an encryption code, or deleting the data. The various data loss prevention rules may be tied to the risk levels of the account or server (e.g., if an account reaches a certain risk level, trigger this data loss prevention rule) or be event-driven (e.g., a violation of a specific policy).

The data risk mitigation component 122 may receive input from the risk detection component 124, which evaluates the risk level associated with individual data requests, user accounts, processes, and systems. When the risk detection component 124 identifies a high-risk request or behavior, the data risk mitigation component 122 may execute a predefined mitigation strategy.

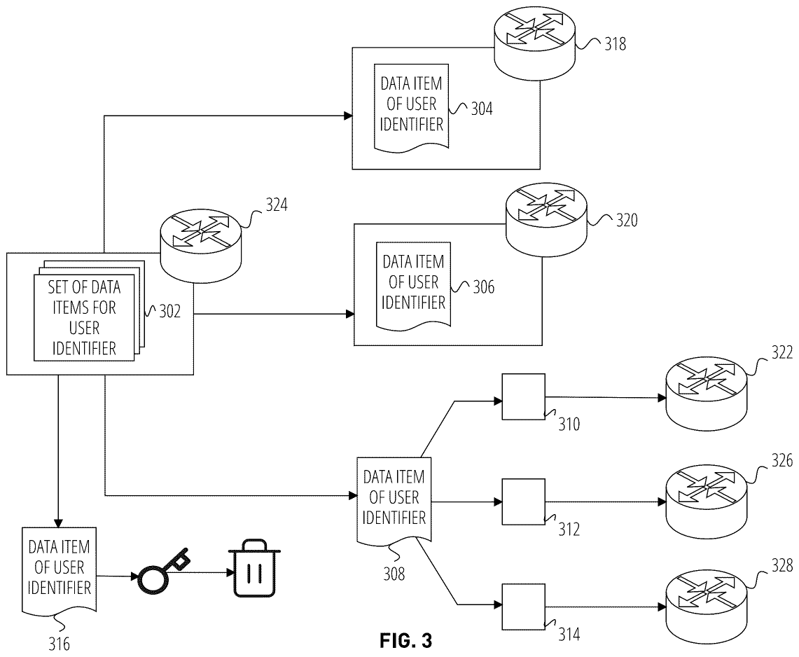

For example, one data loss prevention rule may distribute or replicate the data items of a user across multiple servers, ensuring that even if one server is compromised, the entire data set remains protected. This distribution strategy may involve transmitting different data items to storage devices in various geographic locations, as depicted in FIG. 3.

Another data loss prevention rule may implement encryption methods where keys are automatically destroyed after a set period, rendering the data unreadable and effectively deleting the data. This approach ensures that sensitive data is protected even if the physical storage devices are compromised. The data risk mitigation component 122 may also monitor data against destruction criteria and report if data was not deleted when it was supposed to be.

Application server 102 is illustrated as separate elements (e.g., components). However, the functionality of multiple individual elements may be performed by a single element. An element may represent computer program code executable by processing system 112. The program code may be stored on a storage device (e.g., data store 116) and loaded into the memory of the processing system 112 for execution. Portions of the program code may be executed in parallel across multiple processing units. A processing unit may be a grouping of one or more cores of a general-purpose computer processor, a graphical processing unit, an application-specific integrated circuit, or a tensor processing core. Furthermore, the grouping may operate on a single device or multiple devices (either collocated or geographically dispersed). Accordingly, code execution using a processing unit may be performed on a single device or distributed across multiple devices. In some examples, using shared computing infrastructure, the program code may be executed on a cloud platform (e.g., MICROSOFT AZURE® and AMAZON EC2®).

In some examples, communication between client device 104 and application server 102 may occur using an application programming interface (API) such as API 114. An API provides a method for computing processes to exchange data. A web-based API (e.g., API 114) may permit communications between two or more computing devices, such as a client and a server. The API may define a set of HTTP calls according to Representational State Transfer (RESTful) practices. For example, A RESTful API may define various GET, PUT, POST, and DELETE methods to create, replace, update, and delete data stored in a database (e.g., data store 116), such as data item items.

Application server 102 may include web server 108 to enable data exchanges with client device 104 via web client 106. Although generally discussed in the context of delivering webpages via the Hypertext Transfer Protocol (HTTP), other network protocols may be utilized by web server 108 (e.g., File Transfer Protocol, Telnet, Secure Shell, etc.). A user may enter a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 108. In response, web server 108 may transmit a web page rendered on a client device's display device (e.g., a mobile phone, desktop computer, etc.).

Additionally, web server 108 may enable users to interact with one or more web applications provided in a transmitted web page. A web application may provide user interface (UI) components rendered on a display device of the client device 104. The user may interact (e.g., select, move, enter text into) with the UI components, and, based on the interaction, the web application may update one or more portions of the web page. A web application may be executed in whole or in part locally on client device 104. The web application may populate the UI components with data from external or internal sources (e.g., data store 116) in various examples.

The web application may be executed according to application logic 110. Application logic 110 may use the various elements of application server 102 to implement the web application. For example, application logic 110 may issue API calls to retrieve or store data from data store 116 and transmit it for display on client device 104. Similarly, data entered by a user into a UI component may be transmitted using API 114 back to the web server. Application logic 110 may use other elements (e.g., data protection policies 120, data risk mitigation component 122, risk detection component 124, etc.) of application server 102 to perform functionality associated with the web application as described further herein.

Data store 116 may store data that is used by application server 102. Data store 116 is depicted as a singular element but may be multiple data stores. The data store 116 may include several databases of varying model architectures such as, but not limited to, a relational database (e.g., SQL), a non-relational database (NoSQL), a flat-file database, an object model, a document details model, graph database, shared ledger (e.g., blockchain), or a file system hierarchy. Data store 116 may store data on one or more storage devices (e.g., a hard disk, SAN, NAS Array, SSD, random access memory (RAM), etc.). The storage devices may be in standalone arrays, part of one or more servers, and located in one or more geographic areas (e.g., in external storage 126 and external storage 128).

Data structures may be implemented in several ways depending on the programming language of an application or the database management system used by an application. For example, if C++ is used, the data structure may be implemented as a struct or class. In the context of a relational database, a data structure may be defined in a schema. For performance purposes, a NoSQL database may be utilized with JSON data objects.

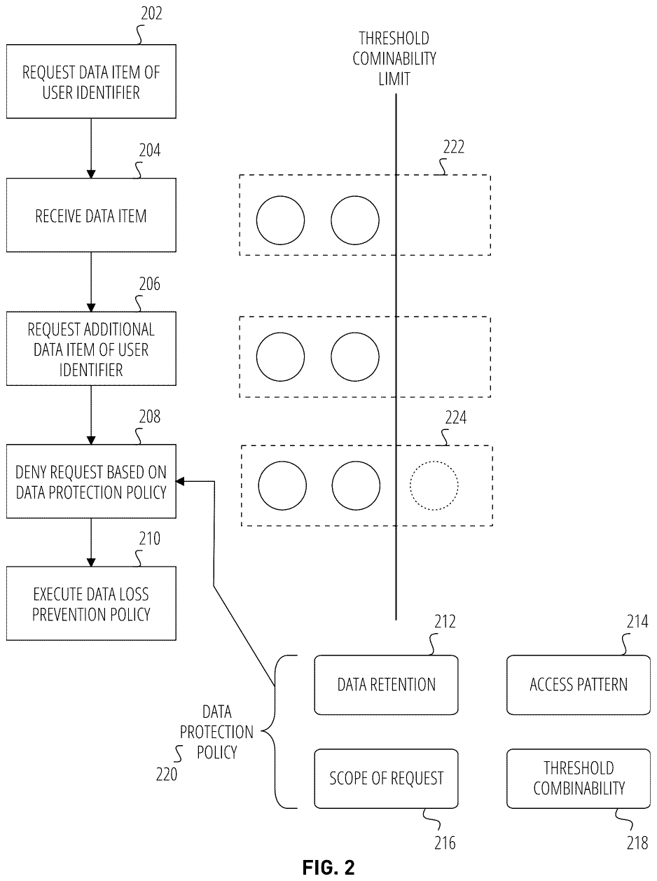

FIG. 2 is a block diagram illustrating the processing of a series of data item requests according to various examples. For discussion purposes, the operations of FIG. 2 describe a relatively simple scenario of two data item requests, but in reality, there may be many more requests (or fewer) in other examples. Consider that a server (e.g., application server 102) receives request operation 202 for a data item associated with a user identifier of a user account. The data item may be a piece of data that, by itself, does not readily identify the user. The request may include an entity identifier (e.g., a process identifier or employee identifier). As visualized in FIG. 2, after receive operation 204, the requesting entity now has two data items in the set of data items 222.

Next, the entity identifier may transmit request operation 206 for an additional data item. The request may be evaluated by a risk detection component such as risk detection component 124 by comparing it to a policy in data protection policy 220 such as a data retention 212, access pattern 214, scope of request 216, or threshold combinability 218 policy. For example, FIG. 2 illustrates the request operation 206 being compared against a threshold combinability limit of two. Thus, the request operation 206 would mean a total of three data items in set of data items 224, which would violate the policy. Consequently, deny operation 208 may be performed and, at data loss prevention operation 210, a data loss prevention rule may be applied (e.g., as visualized in FIG. 3).

FIG. 3 illustrates actions taken in response to a data loss prevention rule, according to various examples. Consider that that set of data items for user identifier 302 is initially stored in a single location (e.g., data storage 324). However, upon a risk detection component indicating a data protection policy has been violated one or more data loss prevention rules may be applied. For example, individual data items (e.g., data item 304 and data item 306) may be distributed to data storage 318 and data storage 320, respectively.

Another data loss prevention rule may chunk (e.g., split) a data item into multiple data subcomponents and distribute them to different storage devices. For example, data item 308 may be split into three data subcomponents, data subcomponent 310, data subcomponent 312, and data subcomponent 314. These data subcomponents may be distributed to their own data storage locations of data storage 322, data storage 326, and data storage 328, respectively, with the replication in place for each storage separately. Another data loss prevention rule may be to delete an encryption key for a data item(s) (e.g., data item 316).

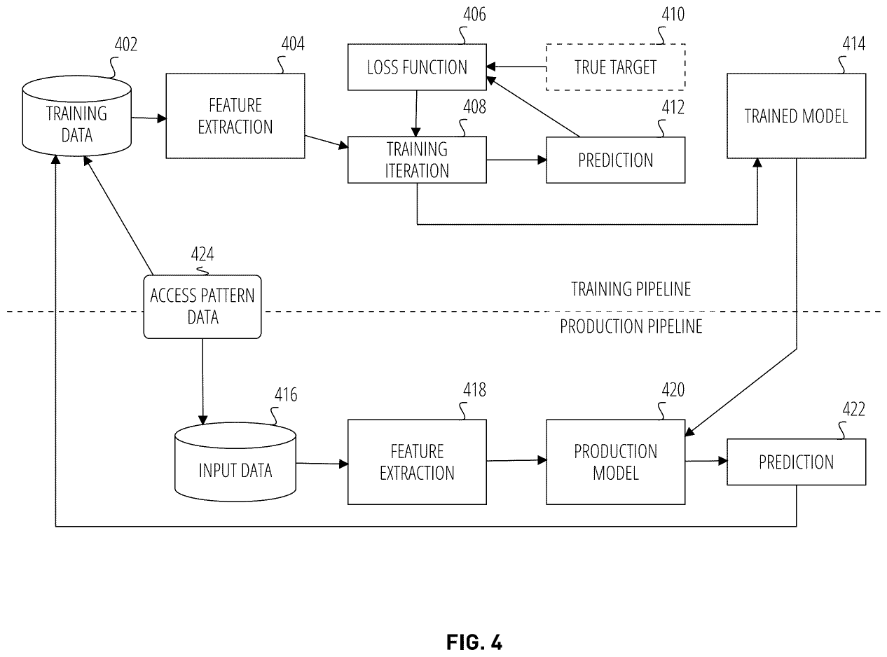

FIG. 4 is a diagram illustrating pipelines for training and using a machine learning model, according to various examples. Machine learning encompasses different algorithms used to predict or classify a data set. In general terms, there are three types of ML algorithms: supervised learning, unsupervised learning, and reinforcement learning—sometimes, a fourth, semi-supervised learning is also used.

Supervised learning algorithms may make a prediction based on a labeled data set (e.g., text with a rating of whether it is spam) and are generally used for classification, regression, or forecasting. Some examples of supervised learning algorithms are Naïve Bayes, Support Vector Machines, Linear Regression, Logistic Regression, Decision Trees, Random Forests, and K-Nearest Neighbor. Unsupervised learning algorithms may use an unlabeled data set (e.g., looking for clusters of similar data based on common characteristics). An example of an unsupervised learning algorithm is K-mean clustering.

Reinforcement learning algorithms generally make a prediction/decision, and then a user determines whether the prediction/decision was right—after which the machine learning model may be updated. This type of learning may be helpful when a limited input data set is available.

Neural networks (also called artificial neural networks (ANN)) are a subset of ML algorithms that may be used to solve problems similar to those of the machine learning algorithms listed above. ANNs are computational structures that are loosely modeled on biological neurons. Generally, ANNs encode information (e.g., data or decision making) via weighted connections (e.g., synapses) between nodes (e.g., neurons). ANNs have many AI applications, such as automated perception (e.g., computer vision, speech recognition, contextual awareness, etc.), automated cognition (e.g., decision-making, logistics, routing, supply chain optimization, etc.), automated control (e.g., autonomous cars, drones, robots, etc.), among others. The weights may be updated using a gradient descent technique during the training process.

Regarding FIG. 4, training a machine learning model begins by collecting training data 402. The training data 402 may include access pattern data 424. Access pattern data 424 may represent a session of data item access requests received over a period of time. These access patterns may include metrics such as the frequency of access requests, the time of day when requests are made, the types of data being requested, and the locations from which the requests originate.

The training data 402 may be labeled according to whether past data item access request(s) were “good” or “bad,” with a zero representing “good” and a one representing “bad.” Each access pattern may be defined as a sequence of user actions commencing with an attempt to request data items of a user. For example, a “good” pattern might include a user logging in from a known location and accessing a reasonable amount of data. In contrast, a “bad” pattern might involve multiple access attempts from different locations within a short time frame, indicating potential malicious activity.

Feature extraction 404 may include normalization and quantification of the training data 402. For example, a vector having one or more dimensions may be generated and include data encoded from each past user set of data requests. This process involves transforming raw data into a format suitable for machine learning algorithms. Features may include numerical values representing the frequency of access requests, categorical values indicating the type of data requested, and binary values representing the success or failure of access attempts. The machine learning model may more effectively learn patterns and make accurate predictions by converting the training data into a structured format.

A training iteration 408 may include inputting a session, as encoded into a vector format, into a machine learning model (e.g., neural network, k-means clustering algorithm). The model may then output a prediction 412. For a neural network, outputting the prediction may include outputting a value indicating the probability that the request was good or bad. This probability score helps determine the likelihood of a given access pattern being legitimate or suspicious.

The prediction 412 may be compared to the true target 410, depending on the model type. A true target may be the actual category the session is associated with. The loss function 406 evaluates the model's performance (e.g., how well the predictions match the actual outcomes). Based on this evaluation, the model's parameters (like weights in neural networks) are updated to minimize the loss, such as using gradient descent. In other models, like decision trees, the update mechanism might involve choosing different splits in the data or pruning branches to improve the model's accuracy, or for k-means clustering, the centroids may be recalculated. After a stopping condition, such as the number of epochs for a neural network or convergence for other models, the model may be considered trained (e.g., trained model 414).

Turning to the production pipeline of FIG. 4, the trained model 414 is used as the production model 420. Input data 416 may include real-time data of data item requests. Feature extraction 418 processes the input data similarly to the training data 402, ensuring that the same features are extracted and normalized for consistency. The production model 420 then processes the extracted features from the input data 416 to generate a prediction 422. This prediction indicates whether the current access request is likely legitimate or suspicious based on the patterns learned during training.

Over time, a series of data item requests may be collected and used as further training data to increase the accuracy of the production model 420. This continuous learning process allows the model to adapt to new patterns and behaviors, improving its ability to detect anomalies and potential security threats. By regularly updating the production model with new data, the system may maintain high levels of accuracy and effectiveness in identifying and mitigating risks associated with illicit data item access.

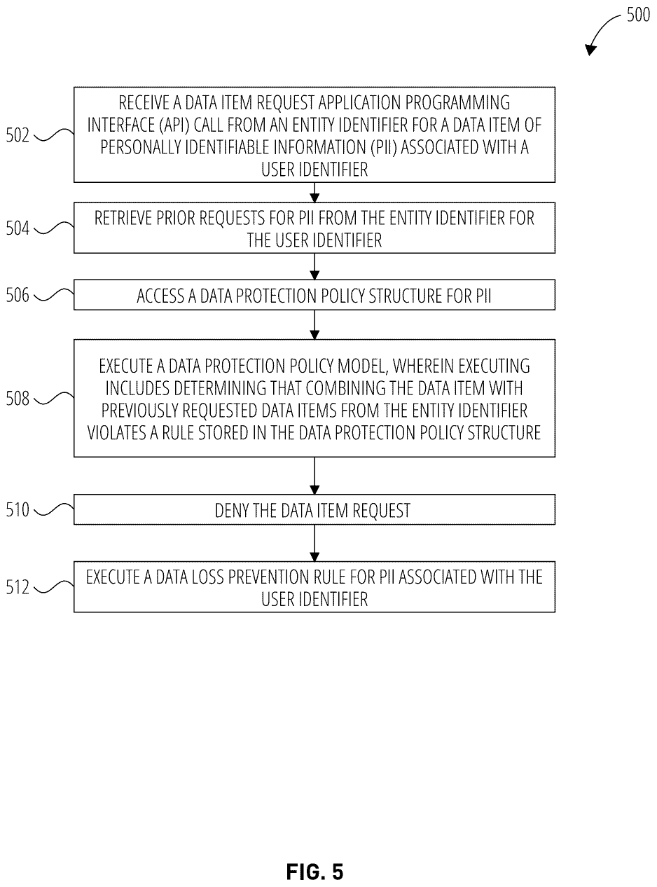

FIG. 5 is a flowchart illustrating a method 500 to execute a data mitigation rule, according to various examples. The method is represented as a set of blocks that describe operations. The method may be embodied in a set of instructions stored in at least one computer-readable storage device of a computing device. A computer-readable storage device excludes transitory signals. In contrast, a signal-bearing medium may include such transitory signals. A machine-readable medium may be a computer-readable storage device or a signal-bearing medium. A processing unit, which executing the set of instructions, may configure the processing unit to perform the operations illustrated in FIG. 5. The processing unit may instruct other component of a computing device to carry out the set of instructions. For example, the processing unit may instruct a network device to transmit data to another computing device or the computing device may provide data over a display interface to present a user interface. In some examples, performance of the method may be split across multiple computing devices using a shared computing infrastructure (e.g., the processing unit encompasses multiple distributed computing devices). As an example, the operations are discussed in the context of the components of FIG. 1 but may be implemented on other systems.

Method 500 includes, at block 502, an operation of receiving a data item request application programming interface (API) call from an entity identifier for a data item of personally identifiable information (PII) associated with a user identifier. The API 114 of the application server 102 may handle this operation. The data item request may include metadata such as the entity identifier, which could be a process identifier or an employee identifier, and the specific PII being requested.

Method 500 includes, at block 504, an operation of retrieving prior requests for PII from the entity identifier for the user identifier. For example, the data store 116 may store records of previous requests, and the application logic 110 may query this data store to retrieve the relevant prior requests.

Method 500 includes, at block 506, an operation of accessing a data protection policy structure for PII. The data protection policies 120 may be stored in a structured format, such as Boolean logic rules or algorithmic rules or JSON format, which the application logic 110 may access. These policies may define the conditions under which PII requests are evaluated.

Method 500 includes, at block 508, an operation of executing a data protection policy model, where executing includes determining that combining the data item with previously requested data items from the entity identifier violates a rule stored in the data protection policy structure. The risk detection component 124 may perform this operation by applying the relevant data protection policies 120 to the current and prior requests. For example, the component may use machine learning models to evaluate whether the combination of data items exceeds a predefined threshold.

The method may also include where the rule stored in the data protection policy data structure for the PII includes a threshold percentage of PII available for the user identifier. For example, the policy may indicate that a requester may not request more than 20% of PII. The data protection policies 120 may define this threshold, and the risk detection component 124 may compare the current request against this threshold to determine compliance.

The method may also include where determining that combining the data item with previously requested data items from the entity identifier violates the rule includes determining that combining the data item with the previously requested data items exceeds the threshold percentage. The risk detection component 124 may calculate the total percentage of PII requested and compare it to the threshold defined in the data protection policies 120.

The method may also include where determining that combining the data item with previously requested data items from the entity identifier violates the rule includes comparing a baseline access pattern for the data item to an access pattern of the entity identifier. The risk detection component 124 may use historical access patterns stored in the data store 116 to establish a baseline and then compare the current request against this baseline to detect anomalies.

The method may also include where the rule stored in the data protection policy data structure for the PII includes a data item expiration period. The data protection policies 120 may specify an expiration period for each data item, and the risk detection component 124 may check whether the requested data item has exceeded this period.

Method 500 includes, at block 510, an operation of, based on the execution at block 508, denying the data item request. The application logic 110 may deny the request by sending a response through the API 114, indicating that the request violates the data protection policy.

Method 500 includes, at block 512, an operation of, based on the execution at block 508, executing a data loss prevention rule for PII associated with the user identifier. The data risk mitigation component 122 may implement this operation by applying predefined data loss prevention rules, such as deleting or distributing the data.

The method may also include where executing the data loss prevention rule for PII associated with the user identifier querying a database for PII associated with the user identifier, and deleting the PII associated with the user identifier. The data risk mitigation component 122 may query the data store 116 to locate the relevant PII and then delete it to prevent unauthorized access.

The method may also include where executing the data loss prevention rule for PII associated with the user identifier includes querying a database for a plurality of data items of PII associated with the user identifier, transmitting a first data item of the plurality of data items to a storage device in a first geographic location, transmitting a second data item of the plurality of data items to a storage device in a second geographic location, and deleting the plurality of data items from the database. The data risk mitigation component 122 may distribute the data items across multiple storage devices, such as external storage 126 and external storage 128, to enhance data security.

The method may also include where executing a data protection policy model includes inputting metadata associated with data item request into a machine learning model trained on past data item requests. The risk detection component 124 may use metadata such as the time of request, location, and entity identifier as input features for a machine learning model to evaluate the request.

The method may also include where the data item of PII is encrypted. Other technical features may be readily apparent to one skilled in the art from the following figures, descriptions, and claims. The method may also include where executing the data loss prevention rule for PII associated with the user identifier includes deleting a decryption key for the data item of PII. The data risk mitigation component 122 may delete the decryption key stored in the data store 116, rendering the encrypted data unreadable.

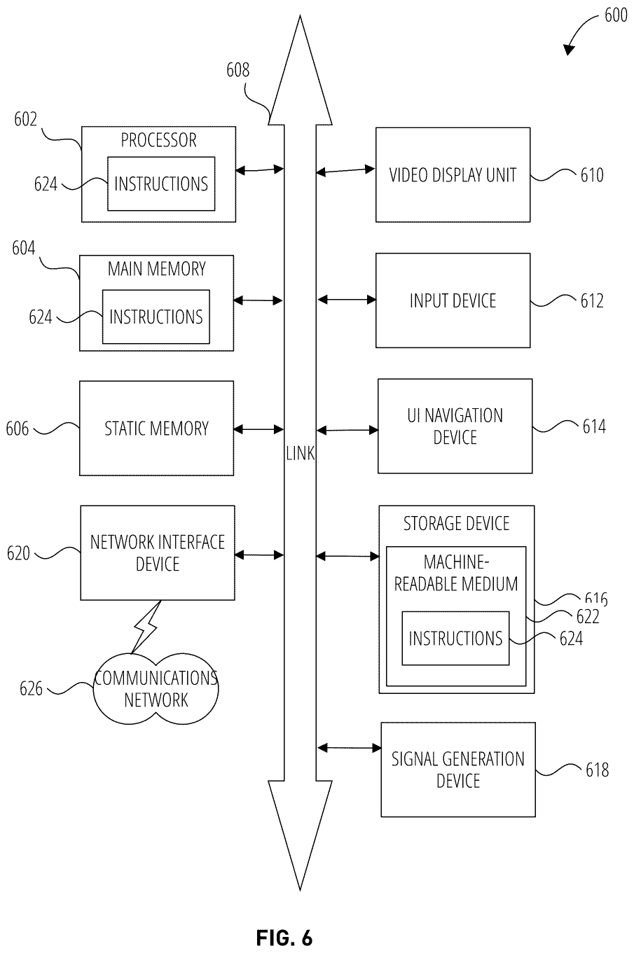

FIG. 6 is a block diagram illustrating a machine in the example form of computer system 600, within which a set or sequence of instructions may be executed to cause the machine to perform any of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) Network environments. The machine may be an onboard vehicle system, wearable device, personal computer (PC), tablet PC, hybrid tablet, personal digital assistant (PDA), mobile telephone, or any machine capable of executing instructions (sequential or otherwise) that specify actions to be taken by that machine. Further, while only a single machine is illustrated, the term “machine” includes any collection of machines that individually or jointly execute a set (or multiple sets) of instructions to perform any of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein

Example computer system 600 includes at least one processor 602 (e.g., a central processing unit (CPU), a graphics processing unit (GPU) or both, processor cores, compute nodes, etc.), a main memory 604, and a static memory 606, which communicate with each other via a link 608. The computer system 600 may include a video display unit 610, an input device 612 (e.g., a keyboard), and a user interface UI navigation device 614 (e.g., a mouse). In an example, the video display unit 610, input device 612, and UI navigation device 614 are incorporated into a single device housing, such as a touchscreen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensors.

The storage device 616 includes a machine-readable medium 622 on which one or more sets of data structures and instructions 624 (e.g., software) embodying or utilized by any of the methodologies or functions described herein. The instructions 624 may also reside, completely or at least partially, within the main memory 604, the static memory 606, or within the processor 602 during execution thereof by the computer system 600, with the main memory 604, the static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database or associated caches and servers) that store the instructions 624. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” includes, but is not limited to, solid-state memories and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 622 that excludes transitory signals.

The instructions 624 may be transmitted or received over a communications network 626 using a transmission medium via the network interface device 620 utilizing a transfer protocol (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine and includes digital or analog communications signals or other intangible mediums to facilitate communication of such software

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A method comprising:
receiving a data item request application programming interface (API) call from an entity identifier for a data item of personally identifiable information (PII) associated with a user identifier;
retrieving prior requests for PII from the entity identifier for the user identifier;
accessing a data protection policy structure for PII;
executing a data protection policy model, wherein executing includes determining that combining the data item with previously requested data items from the entity identifier violates a rule stored in the data protection policy structure; and
based on the executing:
denying the data item request; and
executing a data loss prevention rule for PII associated with the user identifier.

2. The method of claim 1, wherein the rule stored in the data protection policy data structure for PII includes a threshold percentage of PII available for the user identifier.

3. The method of claim 2, wherein determining that combining the data item with previously requested data items from the entity identifier violates the rule includes:
determining that combining the data item with the previously requested data items exceeds the threshold percentage.

4. The method of claim 1, wherein determining that combining the data item with previously requested data items from the entity identifier violates the rule includes:
comparing a baseline access pattern for the data item to an access pattern of the entity identifier.

5. The method of claim 1, wherein the rule stored in the data protection policy data structure for the PII includes a data item expiration period.

6. The method of claim 1, wherein executing the data loss prevention rule for the PII associated with the user identifier includes:
querying a database for PII associated with the user identifier; and
deleting the PII associated with the user identifier.

7. The method of claim 1, wherein executing the data loss prevention rule for PII associated with the user identifier includes:
querying a database for a plurality of data items of PII associated with the user identifier;
transmitting a first data item of the plurality of data items to a storage device in a first geographic location;
transmitting a second data item of the plurality of data items to a storage device in a second geographic location; and
deleting the plurality of data items from the database.

8. The method of claim 1, wherein the data item of PII is encrypted.

9. The method of claim 8, wherein executing the data loss prevention rule for PII associated with the user identifier includes deleting a decryption key for the data item of PII.

10. The method of claim 1, wherein executing the data protection policy model includes inputting metadata associated with data item request into a machine learning model trained on past data item requests.

11. A system comprising:
a processing unit; and
a storage device comprising instructions, which when executed by the processing unit, configure the processing unit to perform operations comprising:
receiving a data item request application programming interface (API) call from an entity identifier for a data item of personally identifiable information (PII) associated with a user identifier;
retrieving prior requests for PII from the entity identifier for the user identifier;
accessing a data protection policy structure for PII;
executing a data protection policy model, wherein executing includes determining that combining the data item with previously requested data items from the entity identifier violates a rule stored in the data protection policy structure; and
based on the executing:
denying the data item request; and
executing a data loss prevention rule for PII associated with the user identifier.

12. The system of claim 11, wherein the rule stored in the data protection policy data structure for PII includes a threshold percentage of PII available for the user identifier.

13. The system of claim 12, wherein determining that combining the data item with previously requested data items from the entity identifier violates the rule includes:
determining that combining the data item with the previously requested data items exceeds the threshold percentage.

14. The system of claim 11, wherein determining that combining the data item with previously requested data items from the entity identifier violates the rule includes:
comparing a baseline access pattern for the data item to an access pattern of the entity identifier.

15. The system of claim 11, wherein the rule stored in the data protection policy data structure for the PII includes a data item expiration period.

16. The system of claim 11, wherein executing the data loss prevention rule for the PII associated with the user identifier includes:
querying a database for PII associated with the user identifier; and
deleting the PII associated with the user identifier.

17. The system of claim 11, wherein executing the data loss prevention rule for PII associated with the user identifier includes:
querying a database for a plurality of data items of PII associated with the user identifier;
transmitting a first data item of the plurality of data items to a storage device in a first geographic location;
transmitting a second data item of the plurality of data items to a storage device in a second geographic location; and
deleting the plurality of data items from the database.

18. The system of claim 11, wherein the data item of PII is encrypted.

19. The system of claim 18, wherein executing the data loss prevention rule for PII associated with the user identifier includes deleting a decryption key for the data item of PII.

20. A non-transitory computer-readable medium comprising instructions, which when executed by a processing unit, configure the processing unit to perform operations comprising:
receiving a data item request application programming interface (API) call from an entity identifier for a data item of personally identifiable information (PII) associated with a user identifier;
retrieving prior requests for PII from the entity identifier for the user identifier;
accessing a data protection policy structure for PII;
executing a data protection policy model, wherein executing includes determining that combining the data item with previously requested data items from the entity identifier violates a rule stored in the data protection policy structure; and
based on the executing:
denying the data item request; and
executing a data loss prevention rule for PII associated with the user identifier.
